(19) United States
(12) Patent Application Publication
(10) Pub. No.: US 2009/0161216 A1
(43) Pub. Date: Jun. 25, 2009

(54) DISPLAY DEVICE AND METHOD FOR MANUFACTURING THE SAME

(75) Inventors: Sung Tae NAM GOONG, Gyeonggi-do (KR); Hyung Sup LEE, Gyeonggi-do (KR)

Correspondence Address: HOSOON LEE, 9600 SW OAK ST. SUITE 525, TIGARD, OR, 97223, US

(73) Assignees: JUSUNG ENGINEERING CO., LTD, Gyeonggi-do, (KR); ADS, Gyeonggi-do, (KR)

(21) Appl. No.: 12/340,664

(22) Filed: Dec. 20, 2008

(30) Foreign Application Priority Data
Dec. 21, 2007 (KR) 10-2007-0135593

(51) Int. Cl. G02B 5/00; G02B 1/00; H01J 9/20

(52) U.S. Cl. 359/513; 428/1.3; 445/25

(57) ABSTRACT

Provided are a display device including a fluid buffer layer and a method for manufacturing the same. The display device includes a display device layer, a passivation layer, an encapsulation layer, and a fluid buffer layer. The display device layer is disposed on one surface of a substrate. The passivation layer is disposed on the display device layer. The encapsulation layer has a cup-shaped internal space to protect the display device layer. The fluid buffer layer is formed on at least one of the top and the side of the passivation layer formed on the display device layer. Because the fluid buffer layer is formed on the display device layer, oxygen and moisture are prevented from flowing into the display device layer, thus suppressing the device lifetime reduction. Also, an external physical impact is absorbed by the fluid buffer layer, thus minimizing the damage to the display device.

### CROSS-REFERENCE TO RELATED APPLICATION

This application claims priority to Korean Patent Application No. 10-2007-0135593 filed on Dec. 21, 2007 and all the benefits accruing therefrom under 35 U.S.C. §119, the contents of which are incorporated by reference in their entirety.

### BACKGROUND

The present disclosure relates to a display device and a method for manufacturing the same, and more particularly, to a display device and a method for manufacturing the same, which can protect the display device against an external physical impact and can also suppress the device lifetime reduction by preventing oxygen and moisture from flowing into a display device layer.

With the advent of the 21st century, importance is being given to the research and development of new display devices. Cathode-ray tubes (CRTs) have led the display market for a long time. However, because the CRPs are heavy and bulky, they are being replaced by liquid crystal displays (LCDs) that are small in weight and lower in power consumption than the CRTs. However, the LCDs have a narrow viewing angle and a low response rate and require high power consumption due to the use of a backlight unit. An organic light emitting device is a typical example of a new display device proposed to overcome the above limitations.

The organic light emitting device is lower in power consumption that the LCD because it is self-luminescent and does not require a backlight unit. Also, the organic light emitting device can provide high-definition display because it has a wide viewing angle and a high response rate.

Meanwhile, an organic material is very vulnerable to moisture and oxygen. This, when moisture and oxygen infiltrate into the organic light emitting device, they may cause a reduction in the device lifetime. Therefore, it is very important to provide an encapsulation technology for protecting an organic emission layer of the organic light emitting device from external environments.

The most widely used encapsulation technology is to cover the top of the organic light emitting device with an encapsulating glass or a metal can. However, it is difficult for the related art encapsulation technology to fully block oxygen or moisture flowing into the organic light emitting device. Also, if the organic emission layer is encapsulated by an encapsulating glass or a metal can, an external physical impact is transmitted without loss to a bottom layer of the organic light emitting device, thus damaging the organic light emitting device.

### SUMMARY

The present disclosure provides a display device and a method for manufacturing the same, which call protect the display device against an external physical impact and also can suppress the device lifetime reduction by preventing oxygen and moisture from flowing into a display device layer.

In accordance with an exemplary embodiment, a display device includes: a display device layer disposed on one surface of a substrate; a passivation layer disposed on the display device layer; an encapsulation layer configured to encapsulate the display device layer and the passivation layer; and a fluid buffer layer disposed between tie passivation layer and the encapsulation layer.

The buffer layer may be disposed in a top region of the display device layer.

The passivation layer may be disposed on the display device layer.

The buffer layer may be formed of a nonvolatile material. The buffer layer may be formed using at least one of liquid crystal, sol and gel. The buffer layer may be formed using at least one of SiO₂, ZrO₂, and GeO₂—SiO₂ of sol or gel type. The display device may further include a spacer disposed between the passivation layer and the encapsulation layer.

The passivation layer may include at least one of an organic material, a coatable high-molecular organic material, and a depositable low-molecular organic material. The inorganic material may include at least one of SiO₂, Al₂O₃, AlON, AlN, Si₃N₄, SiON, and MgO.

The display device layer may be one of a liquid crystal display layer, a plasma display layer, and an organic emission layer.

The encapsulation layer may have the shape of a cup including a top portion and a side portion.

In accordance with another exemplary embodiment, a method for manufacturing a display device includes: forming a display device layer on one surface of a substrate; forming a passivation layer oil the display device layer; dotting a fluid material on the passivation layer; preparing a cup-shaped encapsulation layer configured to encapsulate the display device layer and the passivation layer; inserting the display device layer into the interior space of the encapsulation layer; and attaching the encapsulation layer and the display device layer together. The method may further include forming a spacer in at least one of a top edge of the passivation layer and a bottom edge of the interior space of the encapsulation layer before the inserting of the display device layer.

In accordance with still another exemplary embodiment, a method for manufacturing a display device includes: forming a display device layer on one surface of a substrate; forming a passivation layer on the display device layer; preparing a cup-shaped encapsulation layer configured to encapsulate the display device layer and the passivation layer; forming a spacer in an edge of all interior space of the encapsulation layer; dotting a fluid material on the encapsulation layer; inserting the display device layer into the interior space of the encapsulation layer; and attaching the encapsulation layer and the display device layer together.

In accordance with even another exemplary embodiment, a method for manufacturing a display device includes: forming a display device layer on one surface of a substrate; forming a passivation layer on the display device layer; dotting a fluid material on the passivation layer; preparing a cup-shaped encapsulation layer configured by coating a sealant on the edge of a plate-shaped substrate in the shape of a band; inserting the display device layer into an interior space of the encapsulation layer; and attaching the encapsulation layer and the display device layer together.

In accordance with yet another exemplary embodiment, a method for manufacturing a display device includes: forming a display device layer on one surface of a substrate; forming a passivation layer oil the display device layer; pouring a fluid material into an interior space of a cup-shaped encapsulation layer configured to encapsulate the display device layer and the passivation layer; inserting the display device layer into the interior space of the cup-shaped encapsulation layer; and attaching the encapsulation layer and the display device layer together.

### BRIEF DESCRIPTION OF THE DRAWINGS

Exemplary embodiments can be understood in more detail from the following description taken in conjunction with the accompanying drawings, in which:

FIG. 1 is a cross-sectional view of an organic light emitting device in accordance with an exemplary embodiment;

FIG. 2 is a cross-sectional view of an organic light emitting device in accordance with a modification of an exemplary embodiment;

FIG. 3 is a cross-sectional view illustrating a method for manufacturing an organic light emitting device in accordance with an exemplary embodiment;

FIG. 4 is a cross-sectional view illustrating a method for manufacturing an organic light emitting device in accordance with a modification of an exemplary embodiment;

FIG. 5 is a cross-sectional view illustrating a method for manufacturing an organic light emitting device in accordance with another modification of an exemplary embodiment;

FIG. 6 is a cross-sectional view illustrating a method for manufacturing an organic light emitting device in accordance with still another modification of an exemplary embodiment;

FIG. 7 is a cross-sectional view of an organic light emitting device in accordance with another exemplary embodiment; and

FIG. 8 is a cross-sectional view illustrating a method for manufacturing an organic light emitting device in accordance with another exemplary embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in tie art. Like reference numerals in the drawings denote like elements, and thus their description will be omitted.

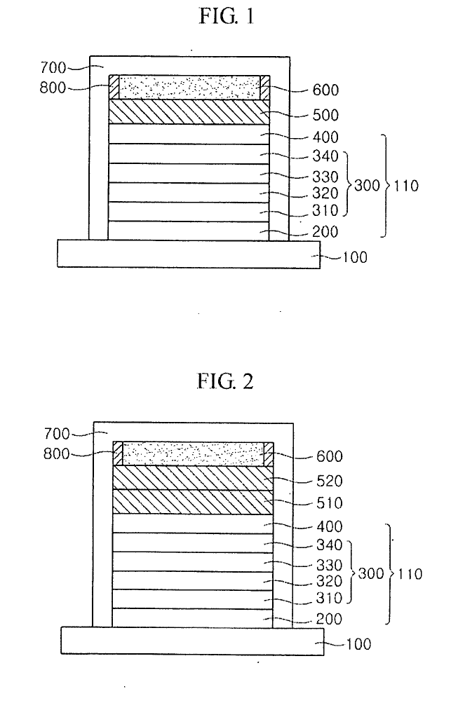

FIG. 1 is a cross-sectional view of an organic light emitting device in accordance with an exemplary embodiment.

Referring to FIG. 1, an organic light emitting device in accordance With this embodiment includes a substrate 100, an organic emission layer 110 disposed on the substrate 100, a passivation layer 500 disposed on the organic emission layer 110, an encapsulation layer 700 encapsulating the organic emission layer 110 and the passivation layer 500, and a buffer layer 600 disposed between the passivation layer 500 and the encapsulation layer 700.

Herein, the substrate 100 may be formed of a transparent material. The type of the substrate 100 is not limited, and the substrate 100 may be formed of various materials Such as glass and plastic.

The organic emission layer 110 includes a positive electrode 200, an organic layer 300, and a negative electrode 400.

The positive electrode 200 may be formed using a material with a high work function so that holes can be injected into the organic layer 300. In the case of a back emission mode, the positive electrode 200 may be formed using a transparent electrode such as indium tin oxide (ITO) and indium zinc oxide (IZO), and in the case of a front emission mode, the positive electrode 200 may be formed using a material with high reflectivity. That is, the positive electrode 200 may be formed using a double layer of Al and ITO, or may be formed using a metal such as Pt, Ni and Au.

The organic layer 300 includes a hole injection layer (HIL) 310, a hole transport layer (HTL) 320, an emitting layer (EML) 330, and an electron transport layer (ETL) 340. Each organic layer may be added or omitted according to circumstances.

The hole injection layer 310 serves to supply holes, injected from the positive electrode 200, to the hole transport layer 320. Thus, the hole injection layer 310 may be formed using an organic material with a deep Highest Occupied Molecular Orbital (HOMO) level. Accordingly, the hole injection layer 310 may be formed using at least one of CuPc (phthalocyanine copper complex), m-MTDATA (4,4′,4″-tris(3-methylphenylphenylamino)triphenylamine), and 2-TNATA (tris[2-naphthyl(phenyl)amino]amino]triphenlamine).

The hole transport layer 320 may be formed of an organic material having an HOMO level similar to that of the hole injection layer 310 so that holes injected from the hole injection layer 310 can be smoothly transported to the emitting layer 330. The hole transport layer 320 may be formed using at least one of TPD (N,N-dipheny)-N,N′-bis(3-methylphenyl)-1,1′-biphenyl-4,4′-diaminel) and α-NPD (4,4-bis[N-(1-naphtyl)-N-phenyl-amino]biphenyl]).

Holes moved from the positive electrode 200 and electrons moved from the negative electrode 400 are combined at the emitting layer 330 to form exitons and then emit light. The emitting layer 330 may be formed using a monomolecular material such as Alq3 (Tris-(8-hydroxyquinioline)aluminum) and DPVBi (4,4-bis(2,2-diphenylvinyl)-1,1-biphenyl), or a high-molecular material such as PPV(p-phenylenevinylene), MEH-PPV (2-methroxy-5-(2-ethylhexyloxy)-1,4-phen-xylenvinylene), and PT(polythiophene).

The electron transport layer 340 transports electrons, injected from the negative electrode 400, to the emitting layer 330. Thus, the electron transport layer 340 is formed using a material with a low LUMO (Lowest Unoccupied Molecular Orbital) level. The electron transport layer 340 may be formed using at least one of Alq3 (Tris-(8-hydroxyquinoline)aluminum) and Bebq2 (bis(benzo-quinoline)berellium). Also, although not illustrated in the drawings, a hole blocking layer (HBL) may be inserted so that holes cannot be moved to the negative electrode 400 through the hole transport layer 320 and the emitting layer 330. In this case, the hole blocking layer may be formed using at least one of BAlq (bis(2-methyl-8-quinolinate). 4-phenylphentolate), and BCP (2,9-Dimethyl-4,7-diphenyl-1,10-phenanthiroline). The use of the hole blocking layer can increase the recombination efficiency in the emitting layer 330.

The negative electrode 400 may be formed of a material having a low work function and a good current conductivity so that electrons can be smoothly supplied at a low driving voltage. The negative electrode used in a back emission mode may be formed using one of LiF—Al, Li—Al, Mg:Ag, and Ca—Ag. Also, the negative electrode 400 used in a front emission mode may be formed using one of a transparent electrode such as ITO and IZO, a metal such as LiF—Al, Mg:Ag, and Ca—Ag, and combinations thereof. If the negative electrode 400 is formed using the metal material, the negative electrode 400 may be formed to a thickness of several μm or less.

The present invention provides an organic light emitting device having the fluid buffer layer 600 formed on the organic emission layer 110. FIG. 1 is a cross-sectional view of an organic light emitting device in accordance with an exemplary embodiment.

In this embodiment, as illustrated in FIG. 1, a passivation layer 500 is formed on an organic emission layer 110 and a fluid buffer layer 600 is formed on the passivation layer 500. The passivation layer 500 formed on the organic emission layer 110 includes an inorganic material such as SiO₂, SiNx, Al₂O₃, AlON, AlN, MgO, Si₃N₄, and SiON, and the passivation layer 500 may be formed using at least one of them. The inorganic passivation layer 500 may be formed using ion beam deposition, electron vapor deposition, plasma beam deposition, or chemical vapor deposition. Also, the inorganic passivation layer 500 may be formed using atomic layer deposition in order to form a more compact layer.

The present invention is not limited thereto, and the passivation layer may be formed using an organic material. The organic passivation layer may be formed using at least one of a coatable high-molecular organic material and a depositable low-molecular organic material. The organic material may be formed using a thermal evaporator. The high-molecular organic material may be coated using a spin-coating process or an inkjet process by mixing an organic solvent.

FIG. 2 is a cross-sectional view of an organic light emitting device in accordance with a modification of an exemplary embodiment.

Referring to FIG. 2, a passivation layer 500 may be a multiple layer of a first passivation layer 510 and a second passivation layer 520, as well as a single layer. The first and second passivation layers 510 and 520 may be formed using a combination of one or more of the materials of the passivation layer 500. For example, as illustrated in FIG. 2, the first passivation layer 510 is formed and then the second passivation layer is formed thereon. Although not illustrated in the drawings, the first passivation layer 510 and the second passivation layer 520 may be stacked alternately or may be formed into a variety of other multiple passivation layers.

A fluid buffer layer 600 is formed on the passivation layer 500. The buffer layer 600 may be formed of a nonvolatile material. Also, the buffer layer 600 may be formed of a liquid that does not react with external environments such as air and moisture. The buffer layer 600 may be formed using a material with a suitable viscosity so that a fluid material does not flow down the side of the organic emission layer 110. Thus, the fluid buffer layer 600 may be formed using one of liquid crystal, sol and gel. The liquid crystal may include at least one of nematic liquid crystal, cholesteric liquid crystal, and smectic liquid crystal. The sol or gel may include one of SiO₂, ZrO₂, and GeO₂—SiO₂.

As described above, in this embodiment, the buffer layer 600 is formed using a fluid material. Thus, a spacer 800 may be used to prevent the buffer layer 600 from flowing down the sides of the passivation layer 500, the negative electrode 400, the organic layer 300, and the positive electrode 200 and to maintain a constant thickness of the fluid buffer layer 600. The spacer 800 may be formed using a sealant. The spacer 800 may be formed along the top edge periphery of the passivation layer 500 as illustrated in FIG. 1. An interior space defined by the spacer 800, i.e., a top center region of the passivation layer 500 is filled with the fluid buffer layer 600.

Also, the encapsulation layer 700 may be formed using one of encapsulation glass and metal can.

In this embodiment, a space between the passivation layer 500 and the encapsulation layer 700 is filled with the fluid buffer layer 600, thereby preventing oxygen or moisture from flowing into the organic emission layer. Also, an external physical impact is absorbed by the fluid buffer layer 600, thereby preventing damage to the organic light emitting device.

Hereinafter, a method for manufacturing an organic light emitting device will be described with reference to the drawings.

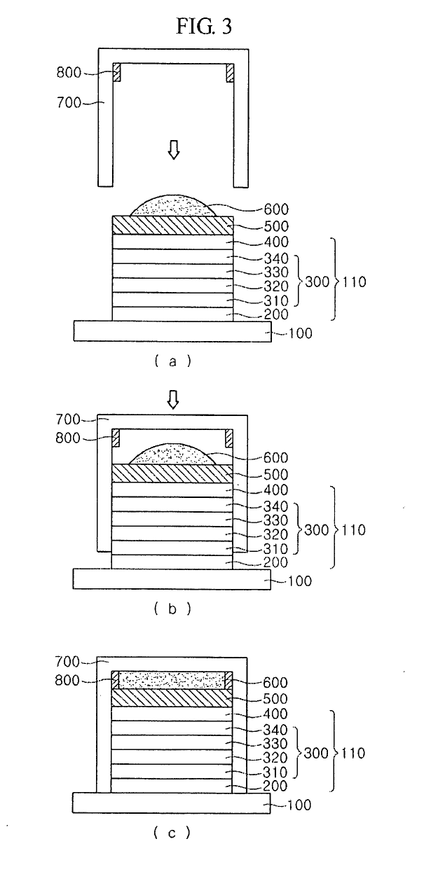

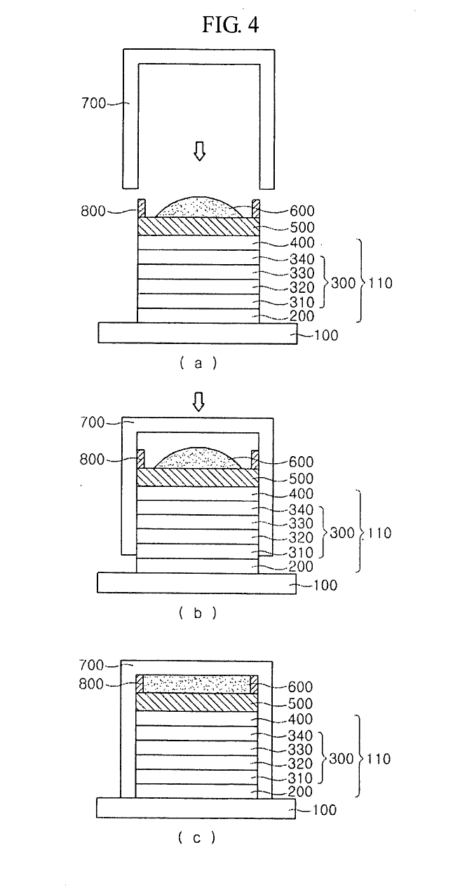

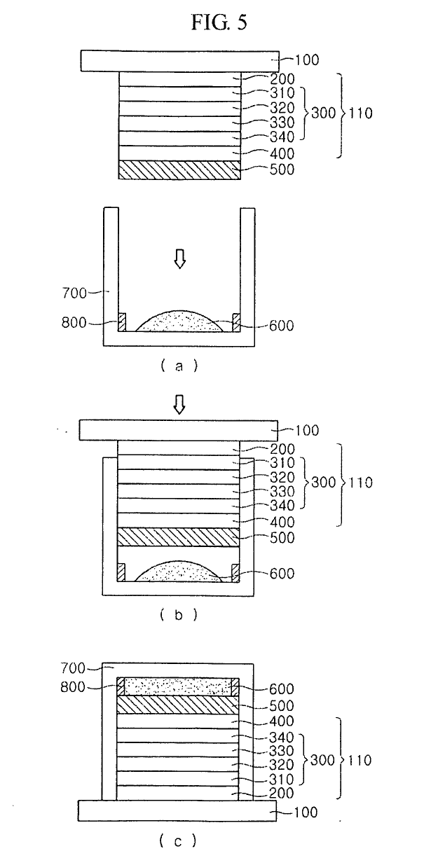

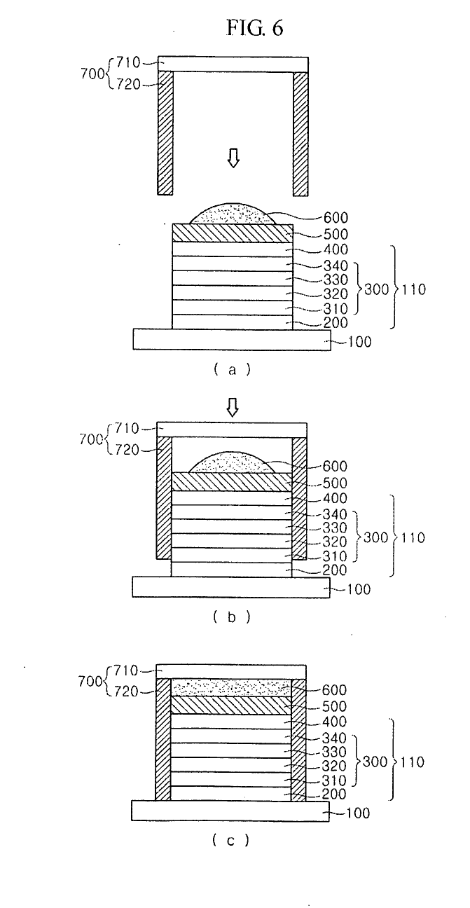

FIG. 3 is a cross-sectional view illustrating a method for manufacturing an organic light emitting device in accordance with an exemplary embodiment. FIG. 4 is a cross-sectional view illustrating a method for manufacturing an organic light emitting device in accordance with a modification of an exemplary embodiment. FIG. 5 is a cross-sectional view illustrating a method for manufacturing an organic light emitting device in accordance with another modification of an exemplary embodiment. FIG. 6 is a cross-sectional view illustrating a method for manufacturing an organic light emitting device in accordance with still another modification of an exemplary embodiment.

Referring to FIG. 3A, an organic emission layer 110 is formed on a substrate 100. A passivation layer 500 is formed on the organic emission layer 110, and a fluid material for a fluid buffer layer 600 is dotted on the passivation layer 500. A spacer 800 is formed at an encapsulation layer 700. The encapsulation layer 700 includes a top portion covering the top of the passivation layer 500 and a side portion covering the side of the organic emission layer 110. That is, the encapsulation layer 700 is formed in the shape of a cup with an interior space. Herein, the spacer 800 is formed in the shape of a band along the bottom edge of the interior space of the encapsulation layer 700. Referring to FIG. 3B, the organic emission layer 110 dotted with a fluid material is inserted into the interior space of the encapsulation layer 700 with the spacer 800. Accordingly, the fluid material dotted on the top of the passivation layer 500 spreads uniformly on the top of the passivation layer 500. At this point, because the space 800 is located at the edge of the top of the passivation layer 500, the spread of the fluid material is blocked by the spacer 800 and is filled in the interior space. Accordingly, the fluid buffer layer 600 with a predetermined thickness can be formed on the top of the passivation layer 500. Referring to FIG. 3C, the organic emission layer 110 and the encapsulation layer 700 are attached together and sealed up, and the sealant is dried by irradiating UV or applying heat thereto. At this point, a caution is given not to expose the organic emission layer 110 to the irradiated UV.

Although not illustrated in the drawings, a sealant may be coated on a combining surface between the substrate 100 and the encapsulation layer 700.

A method of forming a fluid buffer layer 600 is not limited thereto and various modifications may be made therein. That is, referring to FIG. 4, a spacer 800 is formed along the edge periphery of a passivation layer 500 formed on the top of an organic emission layer 110. Referring to FIG. 4A, a fluid material is dotted at the top center of the passivation layer 500. Referring to FIG. 4B, the organic emission layer 110 is inserted into the interior space of a cup-shaped encapsulation layer 700. Referring to FIG. 4C, the organic emission layer 110 and the encapsulation layer 700 are attached together and sealed up, thereby forming a fluid buffer layer 600 between the passivation layer 500 and the encapsulation layer 700.

Also, referring to FIG. 5A, a spacer 800 is formed in an edge region of the bottom of an encapsulation layer 700. A fluid material is dotted in a center region of the interior space of the encapsulation layer 700 with the spacer 800. Referring to FIGS. 5B and 5C, an organic emission layer 110 is inserted into the encapsulation layer 700, and the organic emission layer 110 and the encapsulation layer 700 are attached together and sealed up.

Also, referring to FIG. 6, a fluid material is dotted on the top of a passivation layer 500 formed on an organic emission layer 110. In this modified embodiment, an encapsulation layer 700 is formed by coating a sealant on the top edge of a separate plate-shaped substrate in the shape of a band. Thus, the encapsulation layer 700 includes a top portion 710 covering the top of the passivation layer 500 and a side portion 720 covering the side of the organic emission layer 110. Herein, the side portion 720 of the encapsulation layer 700 serves as a spacer confirming a fluid buffer layer 600 and also serves to cover the side of the organic emission layer 110. Thus, the height of the sealant of the encapsulation layer 700 coated on the substrate may be greater than the total height of the organic emission layer 110 and the passivation layer 500 formed on the organic emission layer 110. Referring to FIGS. 6B and 6C, the organic emission layer 110 is inserted into the encapsulation layer 700, and the organic emission layer 110 and the encapsulation layer 700 are attached together and sealed up, thereby forming the buffer layer in the spaced between the encapsulation layer 700 and the top of the passivation layer 500.

Also, although not illustrated in the drawings, as another method of injecting the fluid buffer layer 600, a pressure difference between the inside and the outside of the organic light emitting device may be used to insert the fluid buffer layer 600 into the gap between the organic emission layer 110 and the encapsulation layer 700.

Hereinafter, a description will be give of a method for manufacturing an organic light emitting device in accordance with another exemplary embodiment. In the following description of another exemplary embodiment, a description of an overlap with the above exemplary embodiment will be omitted for conciseness.

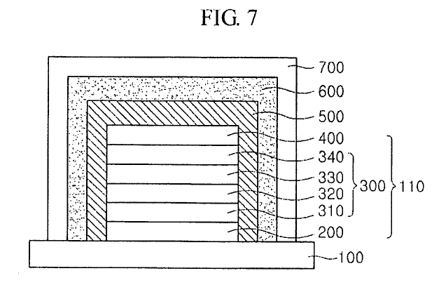

FIG. 7 is a cross-sectional view of an organic light emitting device in accordance with another exemplary embodiment.

Referring to FIG. 7, an organic light emitting device in accordance with this embodiment includes a substrate 100, an organic emission layer 110 disposed on the substrate 100, a passivation layer 500 disposed on the organic emission layer 110, an encapsulation layer 700 encapsulating the organic emission layer 110 and the passivation layer 500, and a fluid buffer layer 600 disposed between the passivation layer 500 and the encapsulation layer 700.

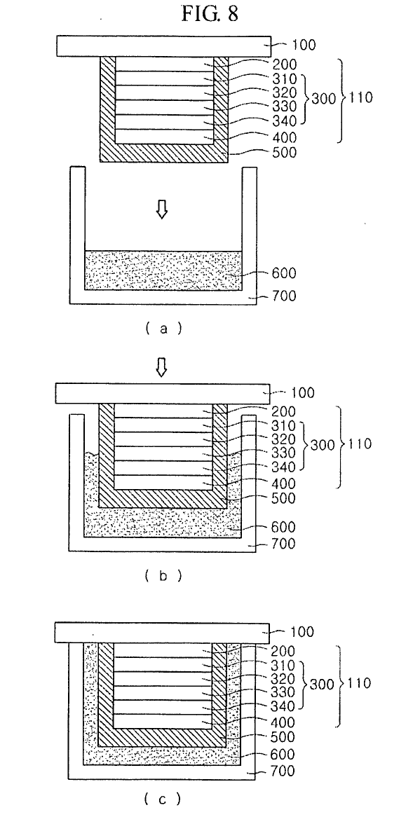

FIG. 8 is a cross-sectional view illustrating a method for manufacturing an organic light emitting device in accordance with another exemplary embodiment.

Referring to FIG. 8A, an organic emission layer 110 is formed on the substrate 100, and a passivation layer 500 is formed on the organic emission layer 110. A fluid material is poured into the bottom of the interior space of a cup-shaped encapsulation layer 700. Referring to FIG. 8B, the organic emission layer 110 is inserted into the interior space of the encapsulation layer 700 filled with the fluid material, and the resulting structure is sealed up. Accordingly, the fluid material in the interior space of the encapsulation layer 700 spreads uniformly on the top and side of the passivation layer 500, and a fluid buffer layer 600 is formed in the space between the passivation layer 500 and the encapsulation layer 700. At this point, because the fluid buffer layer 600 is formed on not only the top but also the side of the organic emission layer 110, it is possible to block oxygen and moisture flowing in at the top and side thereof. Also, the fluid buffer layer 600 can minimize not only a physical impact on the top of the organic light emitting device but also a physical impact on the side thereof.

The present invention is not limited thereto. For example, the passivation layer 500 is formed on the organic emission layer 110 and the fluid buffer layer 600 may be formed only on the side of the passivation layer 500. Alternatively, the fluid buffer layer 600 may be formed only on the top of the passivation layer 500. Also, although not illustrated in the drawings, a spacer 800 may be formed to support the fluid buffer layer 600 and maintain a constant thickness of the fluid buffer layer in the space between the encapsulation layer 700 and the passivation layer 500 formed on the organic emission layer 110.

Although the organic light emitting device using the fluid buffer layer has been described above, the present invention is not limited thereto. For protection of a substrate having an element formed thereon, the present invention can also be used in various electronic devices such as a plasma display panel (PDP) and a liquid crystal display (LCD).

In accordance with the present invention as described above, the fluid buffer layer is formed in the interior space between the display device layer and the encapsulation layer. Therefore, oxygen and moisture are prevented from flowing into the display device layer, thus suppressing the device lifetime reduction. Also, an external physical impact is absorbed by the fluid buffer layer, thus minimizing the damage to the display device layer.

Although the display device and the method for manufacturing the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A display device comprising:
a display device layer disposed on one surface of a substrate;
a passivation layer disposed on the display device layer;
an encapsulation layer configured to encapsulate the display device layer and the passivation layer; and
a fluid buffer layer disposed between the passivation layer and the encapsulation layer.

2. The display device of claim 1, wherein the buffer layer is disposed in a top region of the display device layer.

3. The display device of claim 1, wherein the passivation layer is disposed on the display device layer.

4. The display device of claim 1, wherein the buffer layer is formed of a nonvolatile material.

5. The display device of claim 1, wherein the buffer layer is formed using at least one of liquid crystal, sol and gel.

6. The display device of claim 4, wherein the buffer layer is formed using at least one of SiO₂, ZrO₂, and GeO₂—SiO₂ of sol or gel type.

7. The display device of claim 1, further comprising a spacer disposed between the passivation layer and the encapsulation layer.

8. The display device of claim 1, wherein the passivation layer comprises at least one of an inorganic material, a coatable high-molecular organic material, and a depositable low-molecular organic material.

9. The display device of claim 8, wherein the inorganic material comprises at least one of SiO₂, Al₂O₃, AlON, AlN, Si₃N₄, SiON, and MgO.

10. The display device of claim 1, wherein the display device layer is one of a liquid crystal display layer, a plasma display layer, and an organic emission layer.

11. The display device of claim 1, wherein the encapsulation layer has the shape of a cup comprising a top portion and a side portion.

12. A method for manufacturing a display device, comprising:
forming a display device layer on one surface of a substrate;
forming a passivation layer on the display device layer;
dotting a fluid material on the passivation layer;
preparing a cup-shaped encapsulation layer configured to encapsulate the display device layer and the passivation layer;
inserting the display device layer into the interior space of the encapsulation layer; and
attaching the encapsulation layer and the display device layer together.

13. The method of claim 12, further comprising:
forming a spacer in at least one of a top edge of the passivation layer and a bottom edge of the interior space of the encapsulation layer before inserting the display device layer.

14. A method for manufacturing a display device, comprising:
forming a display device layer on one surface of a substrate;
forming a passivation layer on the display device layer;
preparing a cup-shaped encapsulation layer configured to encapsulate the display device layer and the passivation layer;
forming a spacer in an edge of an interior space of the encapsulation layer;
dotting a fluid material on the encapsulation layer;
inserting the display device layer into the interior space of the encapsulation layer; and
attaching the encapsulation layer and the display device layer together.

15. A method for manufacturing a display device, comprising:
forming a display device layer on one surface of a substrate;
forming a passivation layer on the display device layer;
dotting a fluid material on the passivation layer;
preparing a cup-shaped encapsulation layer configured by coating a sealant on the edge of a plate-shaped substrate in the shape of a band;
inserting the display device layer into an interior space of the encapsulation layer; and
attaching the encapsulation layer and the display device layer together.

16. A method for manufacturing a display device, comprising:
forming a display device layer on one surface of a substrate;
forming a passivation layer on the display device layer;
pouring a fluid material into an interior space of a cup-shaped encapsulation layer configured to encapsulate the display device layer and the passivation layer;
inserting the display device layer into the interior space of the cup-shaped encapsulation layer; and
attaching the encapsulation layer and the display device layer together.
